(19) United States
(12) Patent Application Publication
(10) Pub. No.: US 2004/0094658 A1
(43) Pub. Date: May 20, 2004

(54) Pas-Key

(76) Inventor: William Dale Pas-Key, Channelview, TX (US)

Correspondence Address: WILLIAM DALE PASKEY, 17333 RIVER RD., CHANNELVIEW, TX, 77530, US

(21) Appl. No.: 10/615,525

(22) Filed: Jul. 7, 2003

Related U.S. Application Data
(60) Provisional application No. 60/394,348, filed on Jul. 5, 2002.

(51) Int. Cl. B64C 37/02; B64D 5/00

(52) U.S. Cl. 244/2

(57) ABSTRACT

This machine is a mutated creature of all or most technology to produce either a platform that can be bolted to an existing power supply; as well as could be a complete unit that produces the same result of the ability to fly, hover, &/or drive. This solves many problems by offering an alternative; many parking lots already have helicopter pad(s) so being able to fly in & then hover to a parking spot is an asset. Then if you only add the ability to drive on existing streets/highways; you get the most universal transportation available. Later calculating in the factor that you can convert your existing motorcycle or ATV that is in your garage, into this highly sophisticated futuristic flying machine keeps cost down for a smooth transition is the “Pas-Key” to the future. Imagine driving out bound on the freeway & at the fly zone limit, you flip a switch and fly right off the pavement.

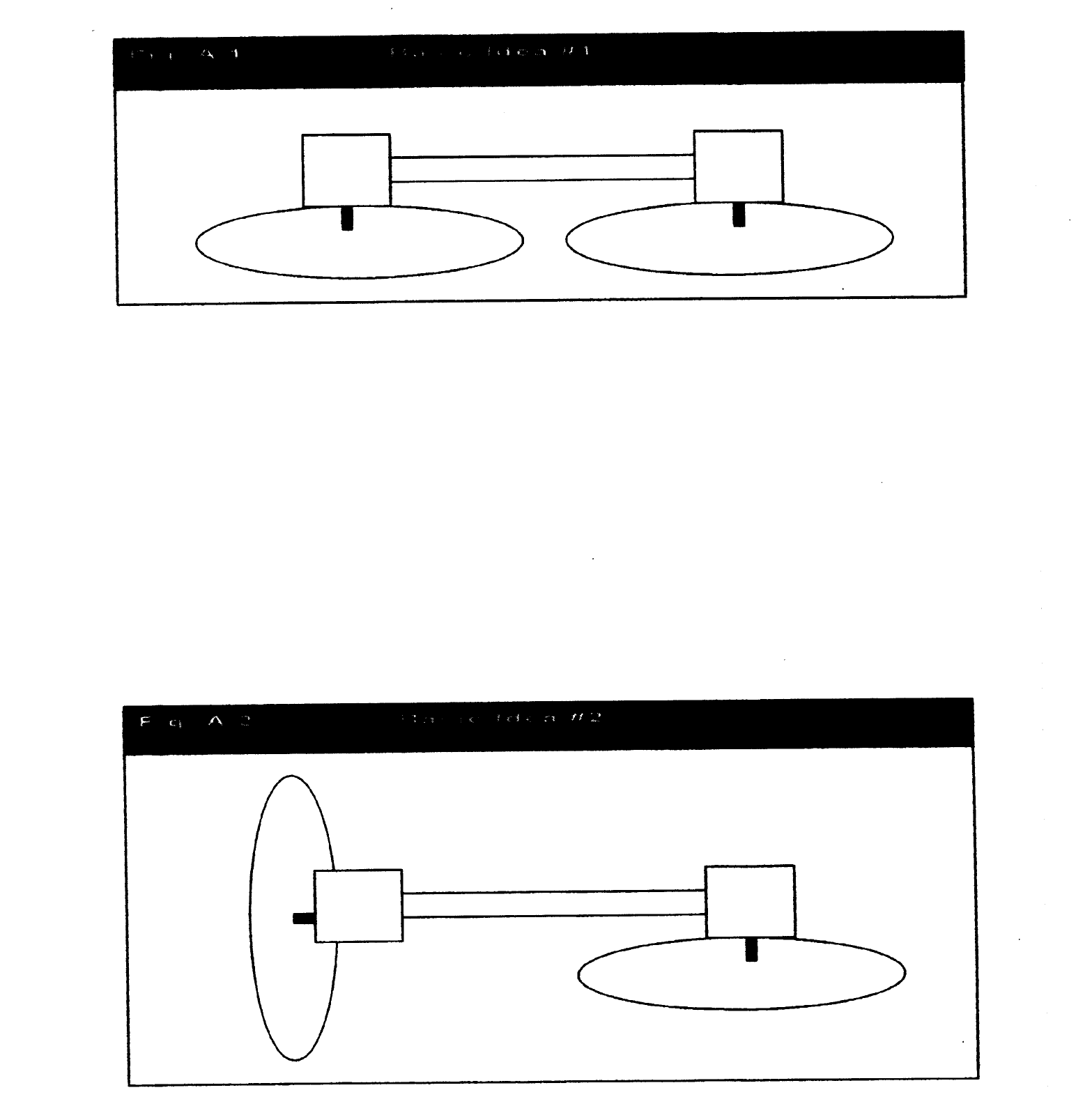

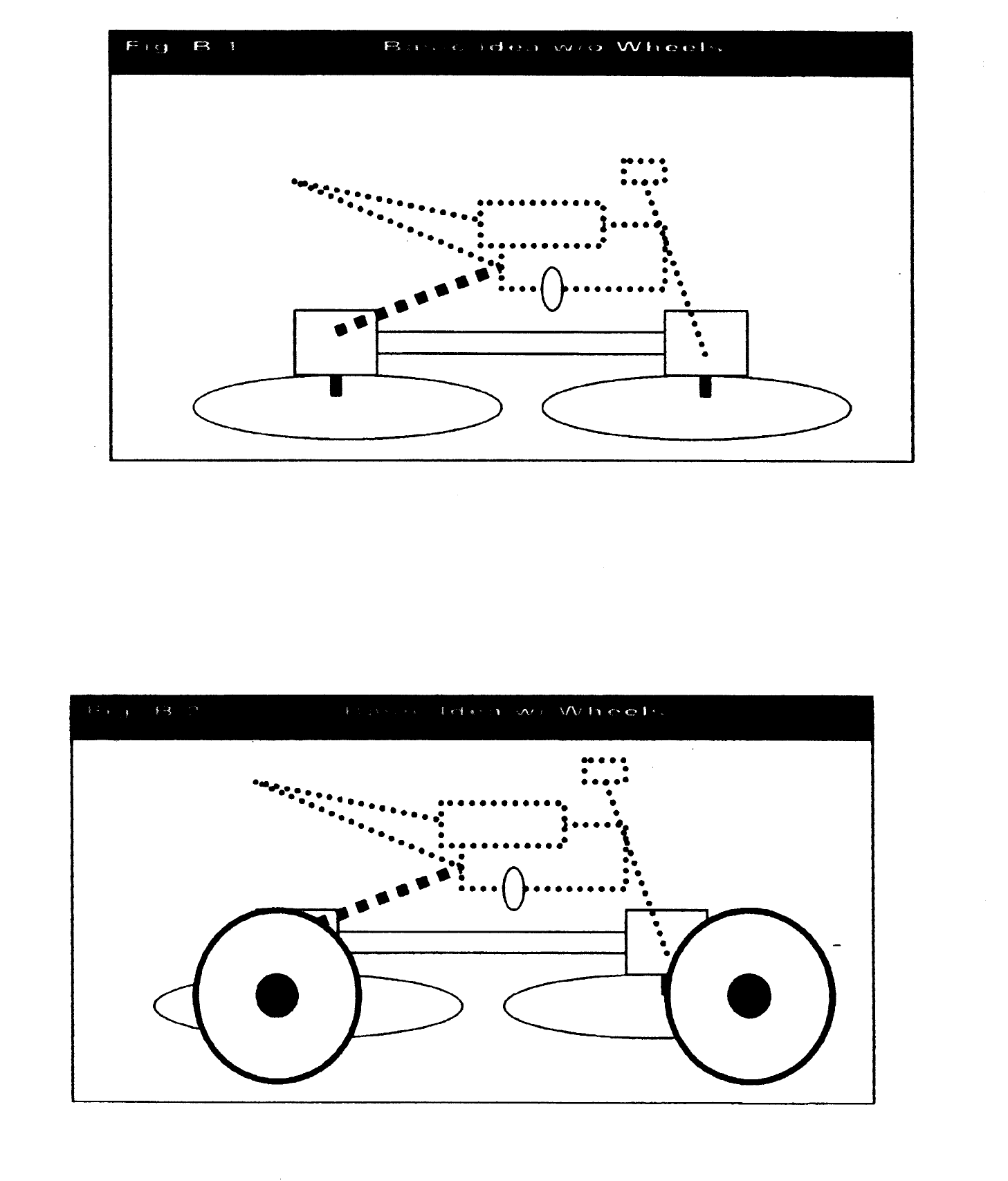

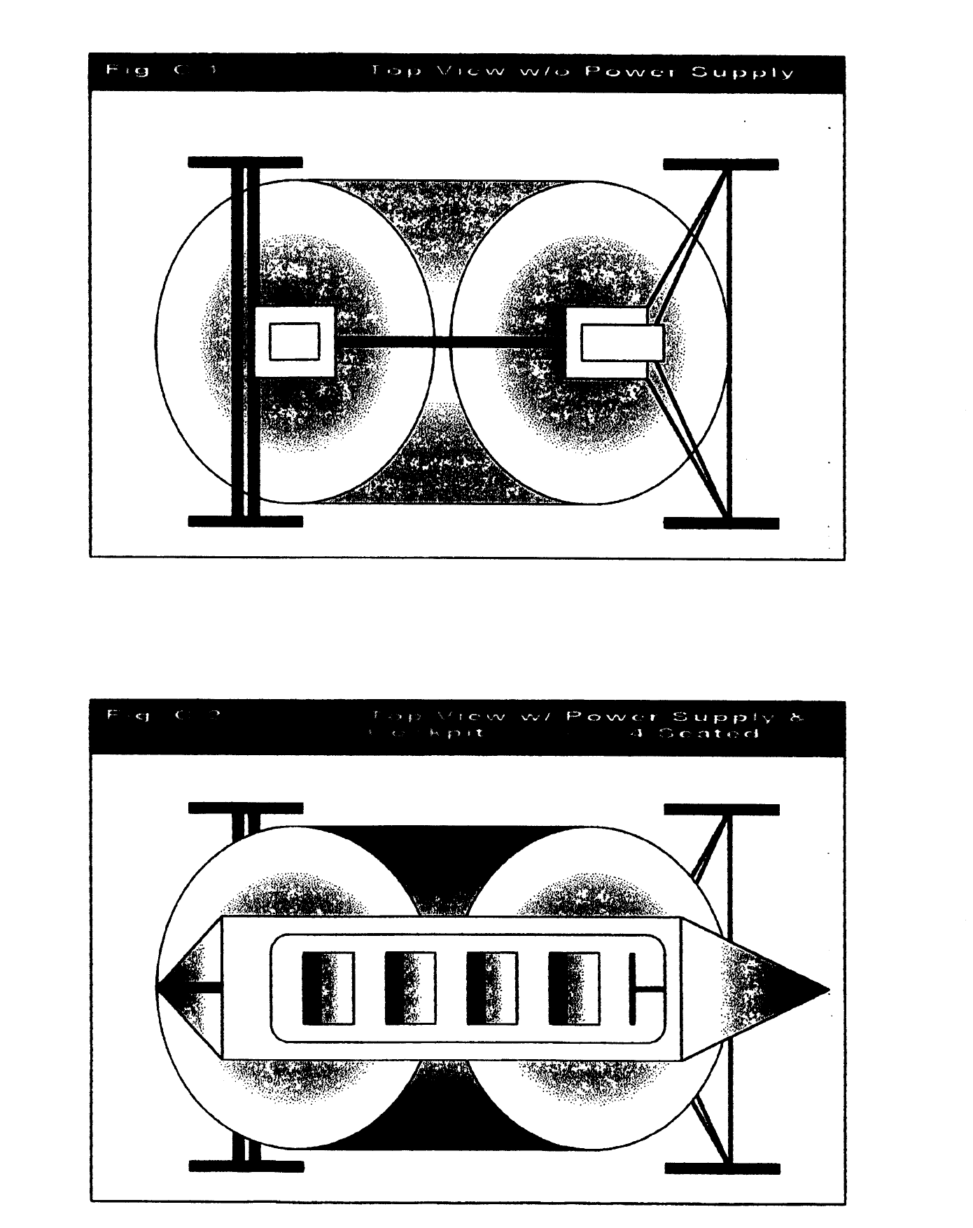

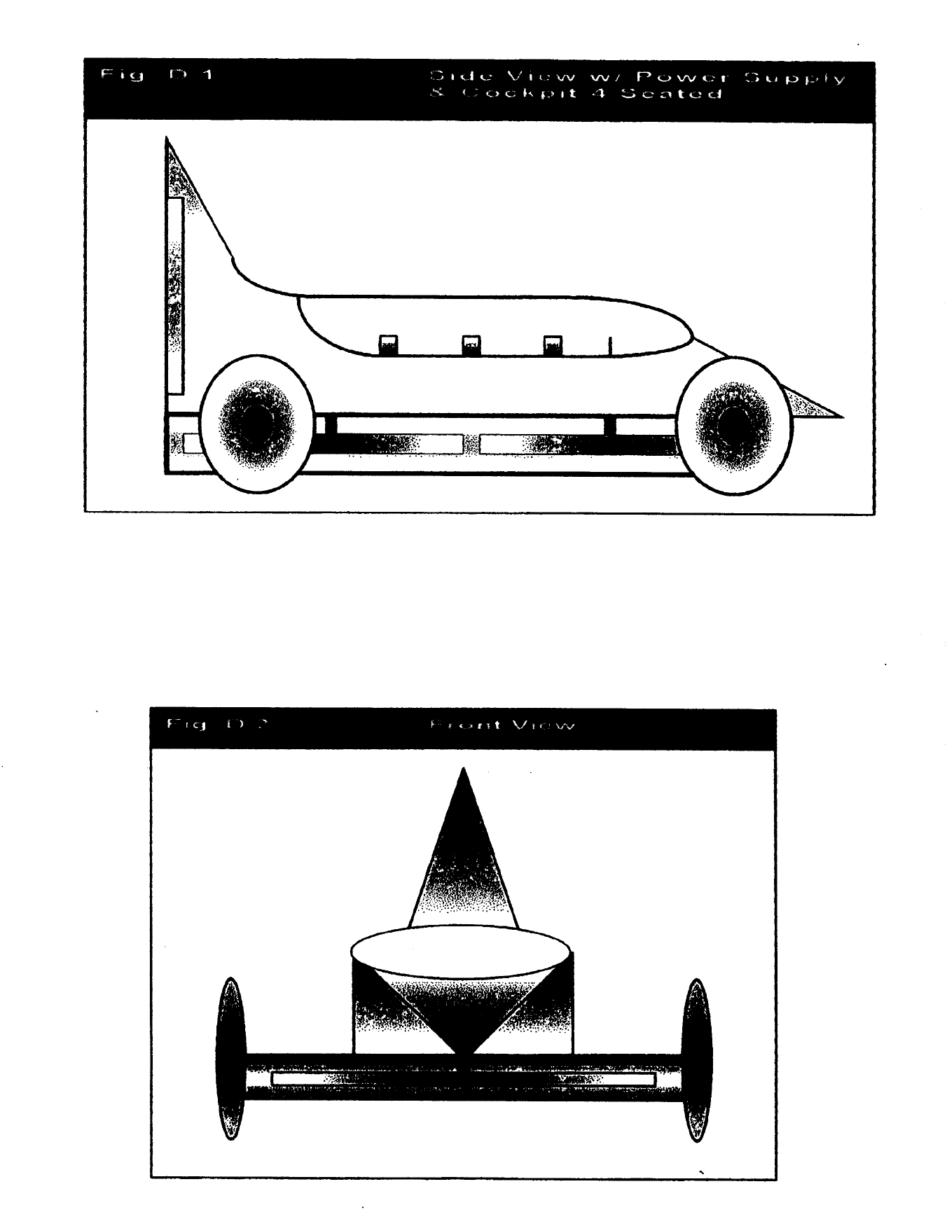

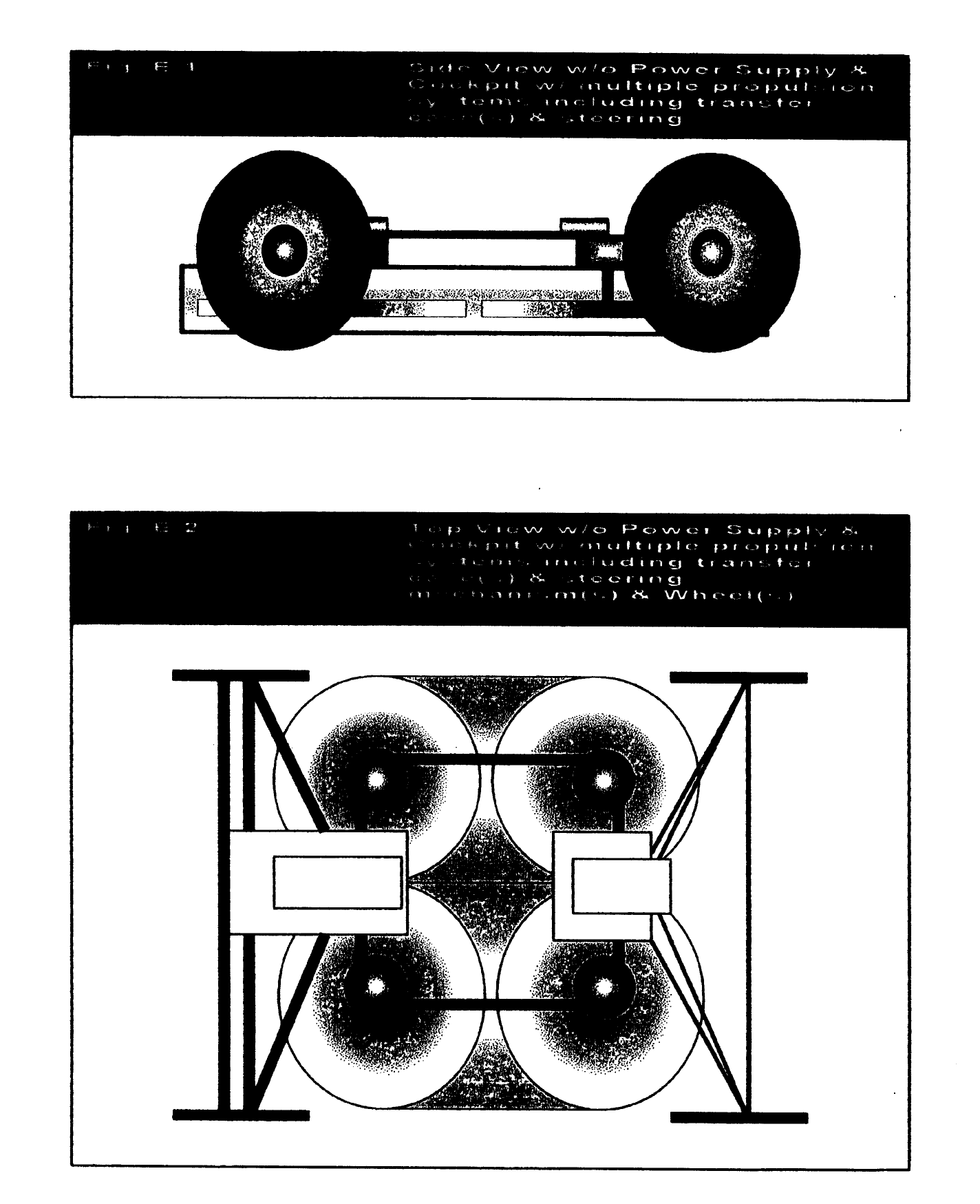

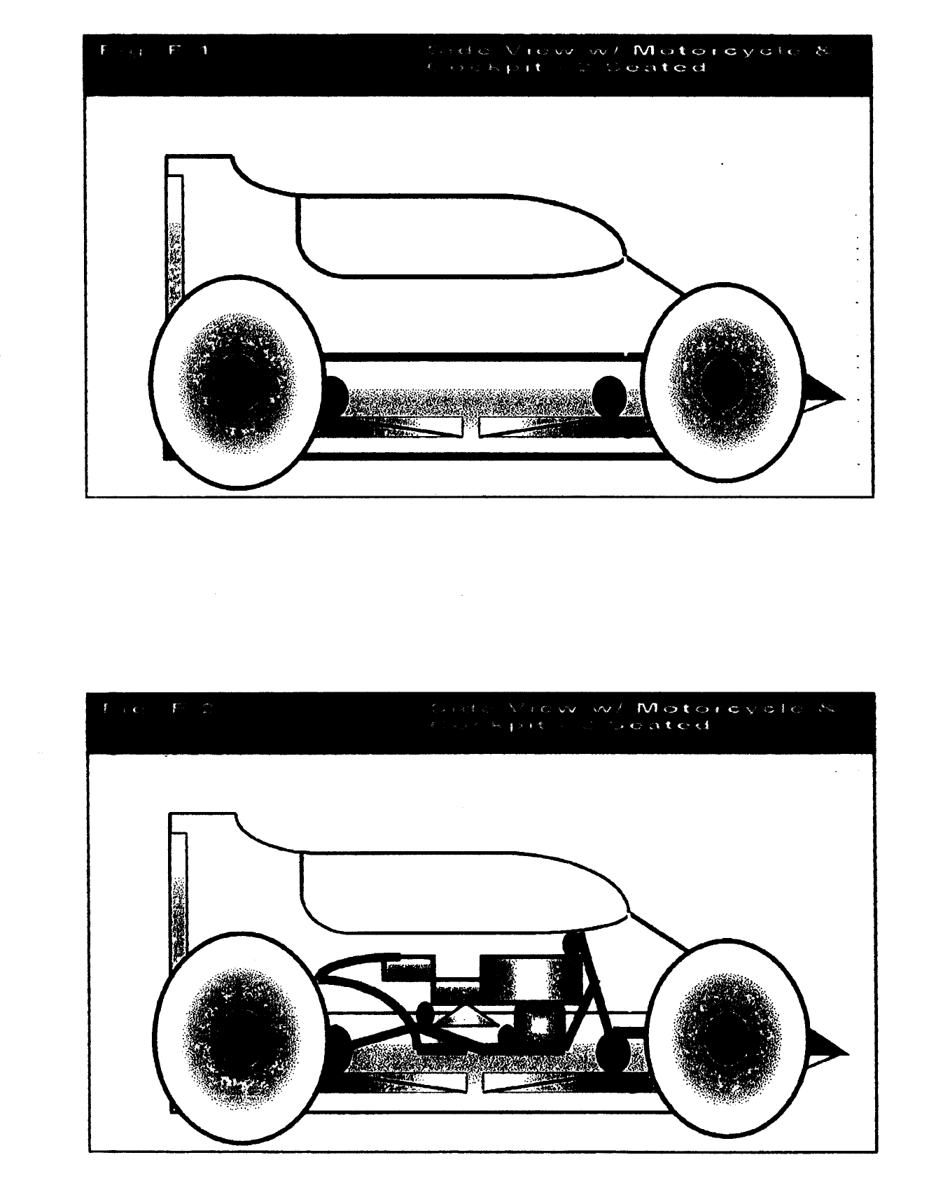

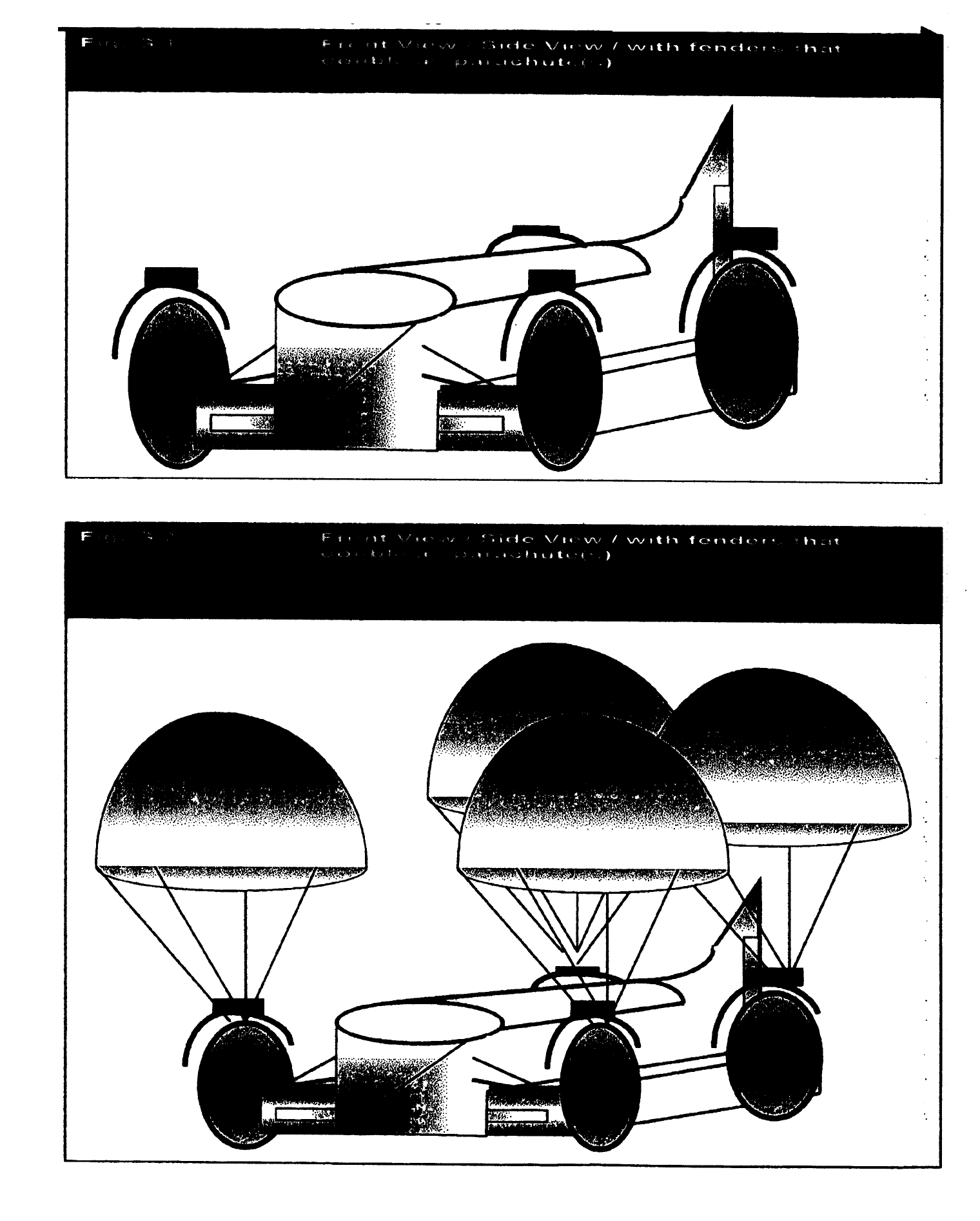

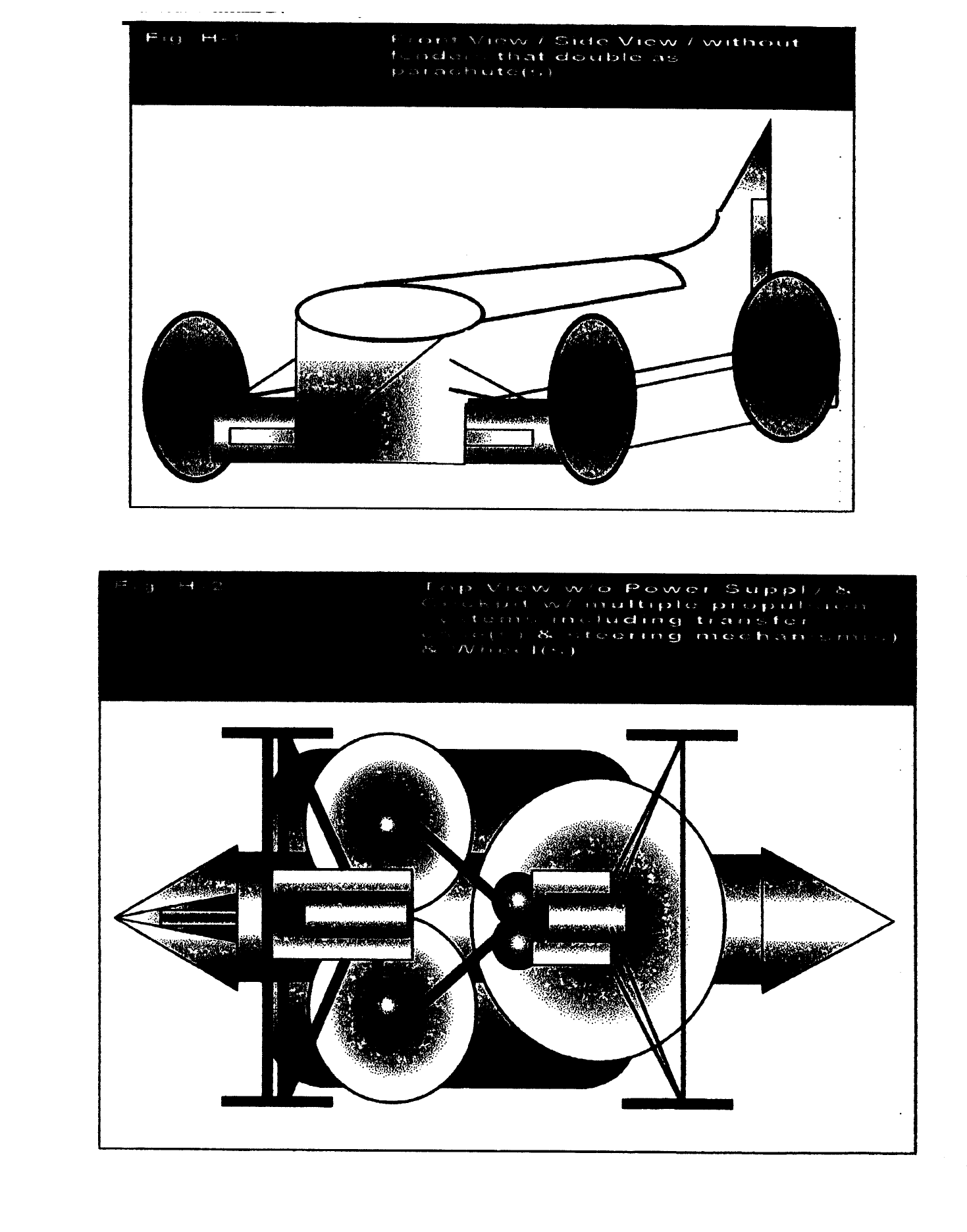

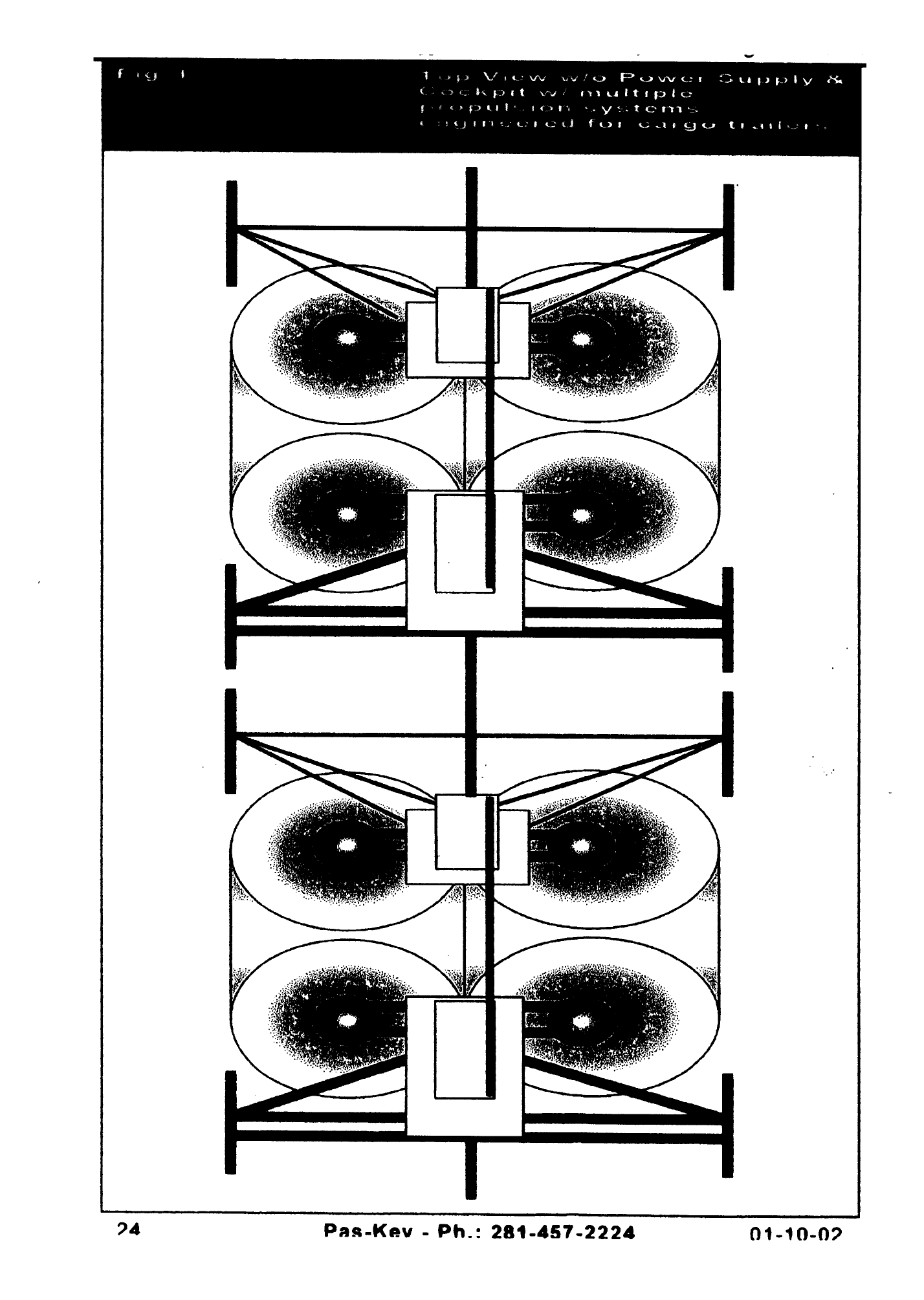

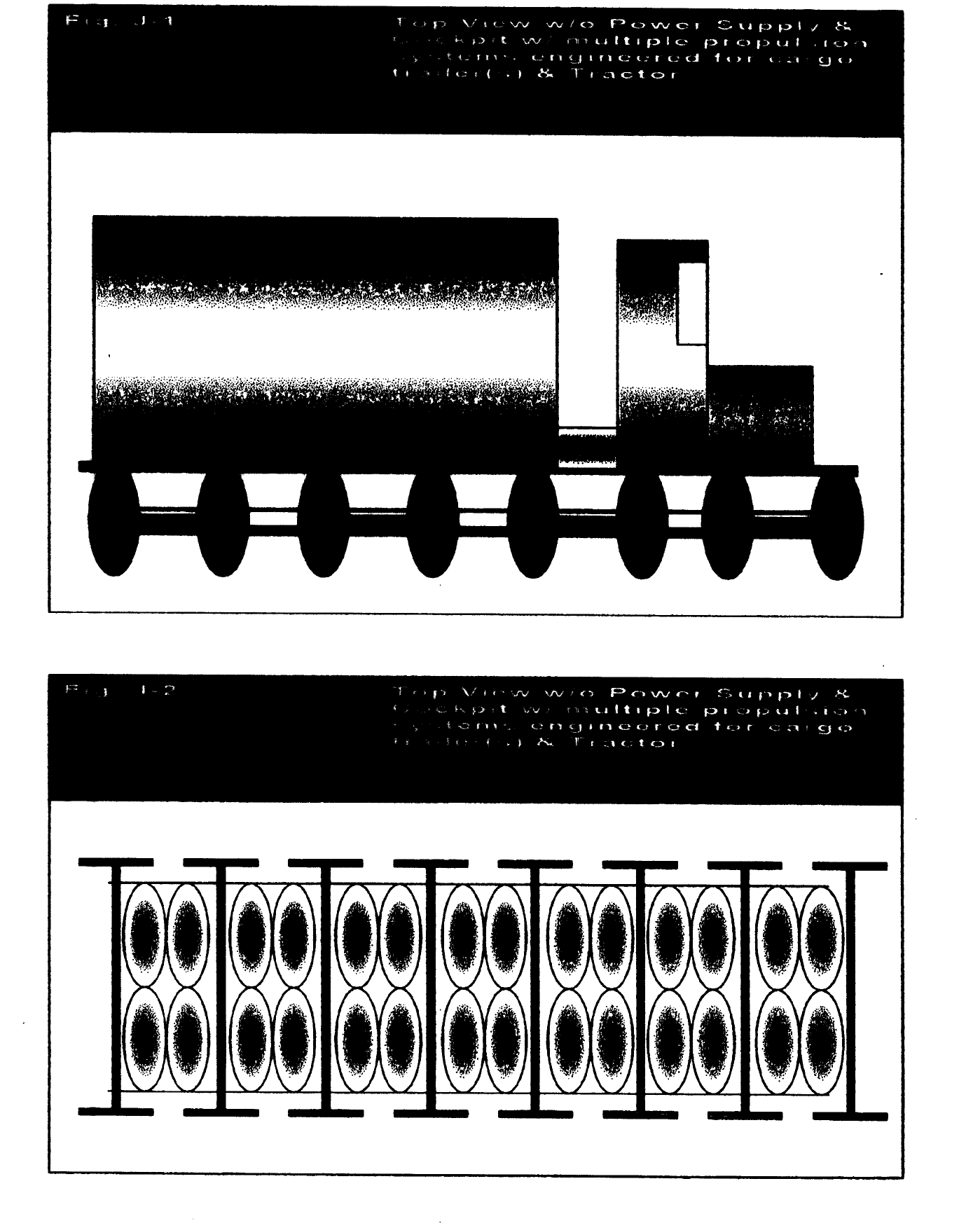

The “PAS-KEY” specification is that it is including but not limited to a flat platform (FIG. C-1) including but not limited to two or more propellers (FIG. E-2) &/or any other propulsion system including but not limited to propellers, turbines, jet power, gravitational propulsion, etc.; that can be attached to any existing power head including but not limited to wave runner, motorcycle, car, tractor, &/or four wheeler to create a flying machine that converts into a hover craft at ground level. With an electronic switch or manually you can go from flying mode in the air, down to hover mode (FIG. A-1), to driving mode (FIG. B-2) allowing the use of existing streets, highway(s), landing pad(s) &/or parking lot(s); which would only have to section off a corner for landing pads or other designated areas. The platform would bolt to the existing rear swing arm & front fork (FIG. B-1); as well as could be custom fit to any power supply (FIG. C-2).

### BACKGROUND OF INVENTION

I have been waiting for approximately ten years to approach the right people at the right time; since aviation classes at San Jacinto College. In the last 6-7 years motorcycle manufacturers have been developing the hottest bike around or even a perfectly balanced motor-cross bike; lots of power in a small package. You get the idea, but my intention(s) are to manufacture an almost universal platform, which is covered by stretched metal for safety that is no larger than a medium size car; adapting the new innovative technology (flying) with current transportation system(s). This idea evolves around the fact that there are no public or private transportation vehicles that offer what Pas-Key is offering. Current technology includes vehicles, motorcycles, a craft made to hover on land or water, airplane & a helicopter; which is no form of public/private transportation device. Pas-Key solves many problems that exist and would be an asset to the world by offering a machine that would decrease travel time between large cities, but still allow the machine to be driven into city limits or in restrict no fly zone area(s). No one offers a personal craft that is designed to adapt to the current transportation system while at the same time promoting the ability to fly. Coming into the 2003 we all realize that we will be flying soon, but just how and when is it going to happen & who is going to be the leader of the industry? Pas-Key is almost like the first motorcycle(s), all terrain vehicle(s) (ATV), personal watercraft(s) (PWC), which was produced; changed the world forever & made manufacturers tons of money. By bringing an affordable option of flying in areas allowable and drive the flying machine in areas flying is not allowed. Adapting to current street legal driving machines keeps the transition to flying affordable. Helicopters offer some options but are not designed to drive on current city streets. HoverCraft offers some options but the design does not include wheels touching the ground for the use of breaks for stopping, again not designed to drive on city streets. The Flying Platform has no wheels with brakes for stopping.

### BRIEF SUMMARY OF INVENTION

It basically involves the basics in aviation technology built with including but not limited to two props counter rotating for stability or including but not limited to any type of propulsion system that have including but not limited to fixed pitch or variable pitch rotors; that could also pivot themselves. Including but not limited to coming with it's own drive between the rotors & including but not limited to a computer that also attaches to the power plants existing electronics, handle bars, chain, etc.; flying this machine should be as easy as riding your motorcycle or four wheeler down the road. This idea offers several different views on all the existing helicopters or personal flying crafts. There is no engine technology on some versions while others would include the power plant. The propulsion system could including but not limited to be beneath the power plant so other available safety equipment comes into play; jet propelled parachute packs for the rider & for low level flying. It differs from all other inventions by being attached to a separate power plant (FIG. A-1); creating a street legal flying machine. Other versions also offer wheels (FIG. B-2) which allow including but not limited to brakes, steering, etc. on the ground driving, but also double as rudders for steering in the air. Other versions could include power plant (FIG. C-2), seats, etc.

### DETAILED DESCRIPTION OF INVENTION

Including but not limited to a platform that has including but not limited to two or more propulsion systems that operated separately from one another by and not limited to RPM, rotation, pitch, &/or other variations to fly, steer, &/or move an existing power plant sold to the public (motorcycle, ATV, wave runner, etc.) or a custom built unit with engine, cockpit, etc. included. Propulsion systems include but are not limited to Jet power, hi/lo frequency audio waveforms, centrifugal force, magnetic rotation, gravitational control, radar fusion powered, tire driven &/or air pressure. The platform could be manual or include computer hardware, chain(s), sprocket(s), drive shaft(s), gearing, steel/aluminum framing & hydraulic system(s) for landing gear with or without wheels; as well as electric motors and other electrical equipment that will move the propulsion systems. The electronic motors could be controlled by electric switches mounted in convenient location(s),(handlebars, foot pegs, frame, etc.); the idea is similar to a controller for a teenager's game (easy as possible, computer controlled). This simple computer controlled platform could include but not be limited to attaching to an existing power plant that fits the specification; which will offer current and future technology to control various aspects such as auto pilot, hover/fly mode, etc. Also including &/or not including the proper retractable/non-retractable, inflatable/non-inflatable skirting needed or not to trap the air in hover mode; made of any material needed like aluminum, canvas, vinyl, steel, plastic, etc. Miniature jets &/or pressured air to help control speed, stopping, turning, etc. Between the two propulsion systems would be a drive line system which could include but not be limited two drive shafts with u-joints, 4×4 transfer case to transition from flying/hover mode to driving mode, chain(s), gearing, gear boxes similar to an automotive rear drive axle, etc. to convert the power from the attached power supply; which could include but not be limited to a motorcycle, ATV, PWC, combustible engine(s), electric motor(s), hydraulic system, centrifugal force, peddling (man/animal power) etc. Steering equipment could attach to existing steering mechanisms of the existing or built power supply; which would allow you to drive on roadways, etc. The wheels could include but not be limited to four in quantity that could include but not be limited to thin, skinny & solid pan shaped inner liner with or without fender/parachute(s) so they would double as movable rudder(s) while in flight/hover; which should increase turning response while moving forward or reverse. Other features could include but not be limited to power steering, rack & pinion systems; as well as other steering mechanism(s) which could be required to completely be mobile &/or legal on the inner city streets & highways. The structural support of the platform would be manufactured from but not limited to aluminum wrapped with stretched metal & could include but not be limited to pipes & tubing around, through, under, or any other way deemed necessary to create vacuum or air pressure; which could assist in stopping or acceleration with blast of air or a large vacuum create by but not limited to closing off louvers, gates, valves, etc. Also including but not limited to additional rudder(s) which could be located but not limited to the rear of the craft for extra maneuverability as well as increase response time; including but not limited to control arms, electric motors, etc. to control the additional rudder(s). The system could also include but not be limited to one solid unit &/or a unit that fold(s) into a smaller unit for the purpose storage &/or any other situation deemed necessary. The propulsion system could including but not limited to be beneath the power plant so other available safety equipment comes into play; jet propelled parachute packs for the rider & for low level flying. It differs from all other inventions by being attached to a separate power plant (FIG. A-1); creating a street legal flying machine. Other versions also offer wheels (FIG. B-2) which allow including but not limited to brakes, steering, etc. on the ground driving, but also double as rudders for steering in the air. Other versions could include power plant (FIG. C-2), seats, etc. 1.Platform &/or 2.Platform with wheels &/or 3.Platform with wheels & power plant.

1. What I claim as my invention is a mutated creature that involves all or most of the existing technology combined together to produce a new innovative machine that involves all the different types of transportation available to the public; flying, hovering, &/or driving. This creature is designed to adapt to the existing transportation system by allowing us to fly to the city limits or a designated landing pad(s) and then drive into the city. Imagine if you will the ability to be driving 60 mph. on an outbound path; reaching the flight limit sign at the edge of the city you flip a switch or lever you get a smooth transition from driving mode, to hover mode, to flying mode without speed variation and fly right off the freeway. To accomplish this goal the creature will include but not be limited to the simplest perfectly balanced high performance platform with (FIG. C-1) or without (FIG. A-1) wheels that can bolt directly to an existing power supply (FIG. B-2) such as a motorcycle (dirt) &/or ATV that could be controlled by leaning forward, left, right, backward, etc. &/or as complex as the most sophisticated computer controlled jet(s) (FIG. D-1) with auto pilot, GPS, radar, AC, heater, radio, video monitor, leveler, power supply, etc. that is as easy as playing your average teenager home video game. The claim incorporates a machine that is equipped to drive (FIG. E-1), to hover (FIG. A-1), to fly &/or to land aquatically as well as on land which is the “Pas-Key” to the future. This creature is a combination of helicopter/hover craft/four-wheeler/automobile/airplane/motorcycle/computer/etc. that is specifically designed for mid to low-level flight &/or the capability to drive, float, or land. The Heli-Hover platform is capable of hovering on the freeway but incorporates driving features so that stopping, turning, etc. is controllable and safer (street legal); as well as more universal and affordable by converting existing motorcycle(s), ATV(s), outboard engine(s), PWC(s), etc. to a fly machine.

2. What I claim as my invention is a mutated creature that involves all or most of the existing technology combined together to produce a new innovative machine that involves all the different types of transportation available to the public; flying, hovering, &/or driving including but not limited to a flat platform (FIG. C-1) including but not limited to two or more propellers (FIG. E-2) &/or ay other propulsion system including but not limited to propellers, turbines, jet power, gravitational propulsion, etc.; that can be attached to any existing power head including but not limited to wave runner, motorcycle, car, tractor, &/or four wheeler to create a flying machine that converts into a hover craft at ground level. With an electronic switch or manually you can go from flying mode in the air, down to hover mode (FIG. A-1), to driving mode (FIG. B-2) allowing the use of existing streets, highway(s), landing pad(s) &/or parking lot(s); which would only have to section off a corner for landing pads or other designated areas. The platform would bolt to the existing rear swing arm & front fork (FIG. B-1); as well as could be custom fit to any power supply (FIG. C-2).

3. What I claim as my invention is a mutated creature that involves all or most of the existing technology combined together to produce a new innovative machine that involves all the different types of transportation available to the public; flying, hovering, &/or driving including but not limited to a flat platform (FIG. C-1) including but not limited to two or more propellers (FIG. E-2) &/or an other propulsion system including but not limited to propellers, turbines, jet power, gravitational propulsion, etc.; that can be attached to any existing power head including but not limited to wave runner, motorcycle, car, tractor, &/or four wheeler to create a flying machine that converts into a hover craft at ground level. With an electronic switch or manually you can go from flying mode in the air, down to hover mode (FIG. A-1), as well as could be custom fit to any power supply (FIG. C-2).
